(19) United States
(12) Patent Application Publication
(10) Pub. No.: US 2020/0122104 A1
(43) Pub. Date: Apr. 23, 2020

(54) Magnetic Stir Bar Catching Means

(71) Applicant: BEVSTIR INNOVATIONS INC., Port Coquitlam (CA)

(72) Inventor: Charn Rai, New Westminster, B.C. (CA)

(21) Appl. No.: 16/606,544

(22) PCT Filed: Apr. 20, 2018
(86) PCT No.: PCT/CA2018/050475

§ 371 Date: Oct. 18, 2019

(30) Foreign Application Priority Data
Apr. 21, 2017 (CA) 2964794

(51) Int. Cl. B01F 13/08; B01F 15/00

(52) U.S. Cl. CPC B01F 13/08; B01F 15/00831

(57) ABSTRACT

A container having a recess or a series of projections on the interior side of its wall to catch or restrain a magnetic stir bar during the pouring of contents from the container. The recess or series of projections may extend along the full interior circumference of the container or may be vertically aligned with a spout located at the opening of the container. One or more drainage channels extending from the recess towards the opening of the container may be provided to assist in pouring the contents out of the container.

### FIELD OF THE INVENTION

This invention relates to a container used for the magnetic mixing of substances. In particular, this invention relates to means for preventing a magnetic stir bar from escaping when pouring beverages from the container.

### BACKGROUND OF THE INVENTION

Magnetic mixing utilizing a magnetic stirrer and magnetic stir bar is known. A user places a magnetic stir bar in the container with the substances to be iii mixed and places the container on a magnetic stirrer. The rotating magnetic field created by the magnetic stirrer couples with the magnetic stir bar in the container, causing magnetic stir bar to rotate and mix the substances within the container.

Once the substances are mixed to the desired degree, the magnetic stir bar is typically removed from the container prior to pouring the mixed solution from the container. This can be done by using a stir bar retriever such as a rod with a magnet at one end. However, removal of the magnetic stir bar using such a stir bar retriever can be inconvenient. Not only does the stir bar retriever need to be washed after use, it must also be kept near the magnetic stirrer and magnetic stir bar. Depending on the shape of the container, removal of the magnetic stir bar using a stir bar retriever may also be challenging. For example, some wine decanters have a relatively wide base and a narrow neck which would make it difficult to remove a stir bar in the conventional manner. As disclosed in U.S. Pat. No. 6,332,706 to Hall, it is known to aerate wine using a magnetic stir bar. Avoiding delivery of the stir bar with the wine being poured, for example into a wine glass, is desirable.

It is therefore an object of this invention to provide an alternate means of catching and retaining a magnetic stir bar within a container during pouring.

It is a further object of the invention that the means of catching a magnetic stir bar during pouring be inseparable from the container.

These and other objects of the invention will be better understood by reference to the detailed description of the preferred embodiment which follows. Note that the objects referred to above are statements of what motivated the invention rather than promises. Not all of the objects are necessarily met by all embodiments of the invention described below or by the invention defined by each of the claims.

### SUMMARY OF THE INVENTION

In one aspect, the invention comprises a container having a recess on the interior side of its wall. A magnetic stir bar placed in the container for magnetic mixing purposes is caught by and retained within the recess when the mixed substances are poured from the container.

In another aspect, the invention comprises a container having a base, an opening at the top of the container, and a wall extending between the base and the opening. The wall comprises an interior side, an exterior side, and a recess on the interior side for catching a magnetic stir bar during the pouring of contents from the container.

In a further aspect, the recess on the interior side of the wall extends around the full interior perimeter of the interior side of the wall.

In a further aspect, the container further comprises a spout at the opening and the recess being vertically aligned with the spout.

In a further aspect, the container further comprises at least one drainage channel extending from the recess towards the opening.

In yet a further aspect, the depth of the at least one drainage channel is less than the depth of the recess such that a magnetic stir bar retained in the recess will not move into the at least on drainage channel during the pouring of contents from the container.

In a further aspect, the width of the at least one drainage channel is less than the width of the recess such that a magnetic stir bar retained in the recess will not move into the at least one drainage channel during the pouring of contents from the container.

In a further aspect, the recess is in the form of a spiral.

In a further aspect, the recess extends at least one full rotation around the interior side of the wall.

In a further aspect, the recess extends at least two full rotations around the interior side of the wall.

In a further aspect, the container having a recess is a wine decanter.

In another aspect, the invention comprises an assembly for magnetically mixing one or more substances. The assembly comprises a magnetic mixer, a magnetic stir bar, and a container. The container has a base, an opening at the top of the container, and a wall extending between the base and the opening. The wall comprises an interior side, an exterior side, and a recess on the interior side for catching a magnetic stir bar during the pouring of contents from the container.

In another aspect, the invention comprises a method of mixing one or more substance. The method comprises placing one or more substances in a container. The container has a base, an opening at the top of the container, and a wall extending between the base and the opening. The wall comprises an interior side, an exterior side, and a recess on the interior side for catching a magnetic stir bar during the pouring of contents from the container. The method further comprises placing a magnetic stir bar in the container, powering a magnetic mixer below the container such that the magnetic stir bar within the container spins to mix the one or more substances in the container, and pouring the one or more substances from the container. During the pouring, the magnetic stir bar is caught by the recess on the interior side of the wall.

In another aspect, the invention comprises a container having a base, an opening at the top of the container, and a wall extending between the base and the opening. The wall comprises an interior side, an exterior side, and one or more projections extending inwards from the interior side for restraining a magnetic stir bar during the pouring of contents from the container.

In a further aspect, the one or more projections extend around the full interior perimeter of the interior side of the wall.

In a further aspect, the container further comprises a spout at the opening and the one or more projections are vertically aligned with the spout

In another aspect, the one or more projections form a series of alternating projections and spaces.

In another aspect, the one or more projections are conical in shape.

In another aspect, the one or more projections are finger-like projections.

In another aspect, at least one of the one or more projections has a magnet.

In another aspect, the container having one or more projections is a wine decanter.

The foregoing may cover only some of the aspects of the invention. Other aspects of the invention may be appreciated by reference to the following description of at least one preferred mode for carrying out the invention in terms of one or more examples. The following mode(s) for carrying out the invention is not a definition of the invention itself, but is only an example that embodies the inventive features of the invention.

### BRIEF DESCRIPTION OF THE DRAWINGS

At least one mode for carrying out the invention in terms of one or more examples will be described by reference to the drawings thereof in which:

FIG. 1 is a perspective view of a container according to one embodiment of the invention;

FIG. 2 is a cross-sectional view of the container shown in FIG. 1;

FIG. 3 is a cross-sectional view of a container according to another embodiment of the invention;

FIG. 4 is a perspective view of a container having a spout according to another embodiment of the invention;

FIG. 5 is a cross-sectional view of the container shown in FIG. 4;

FIG. 6 is perspective view of the container shown in FIG. 1 showing a mixed substance being poured out;

FIG. 7 is a cross-sectional view of the container shown in FIG. 6 taken along line A-A and showing a magnetic stir bar caught in a recess located on the interior side of the container's wall;

FIG. 8 is a perspective view of a container according to another embodiment of the invention;

FIG. 9 is a cross-sectional view of the container shown in FIG. 8;

FIG. 10 is a perspective view of a container having a series of projections on the interior side of the container's wall according to another embodiment of the invention;

FIG. 11 is a perspective view of a container having a series of projections on the interior side of the container's wall according to another embodiment of the invention;

FIG. 12 is top plan view of the container shown in FIG. 11 taken along line B-B and showing internal magnets within the series of projections;

FIG. 13 is a perspective view of the container shown in FIG. 11 showing a substance being poured out; and

FIG. 14 is a cross-sectional view of the container shown in FIG. 13 taken along line C-C and showing a magnetic stir bar being restrained by the series of projections.

### DETAILED DESCRIPTION OF AT LEAST ONE MODE FOR CARRYING OUT THE INVENTION IN TERMS OF EXAMPLE(S)

FIG. 1 shows a container 2. The particular container 2 shown in FIG. 1 has a narrow, tapered neck 4 and a wide, lower portion 6 that is typical of many wine decanters. However, it will be appreciated that the type (and shape) of the container 2 of FIG. 1 and the alternate containers shown in the remaining drawings may vary. For instance, the container may be a cylindrical beverage tumbler or a laboratory flask.

The container 2 has a base 8 and an opening 10. A container wall 12 extends from the base 8 to the opening 10. The wall 12 has an exterior side that may be grasped and held by a user and an interior side that, in combination with the base, forms the space for holding substances placed into the container.

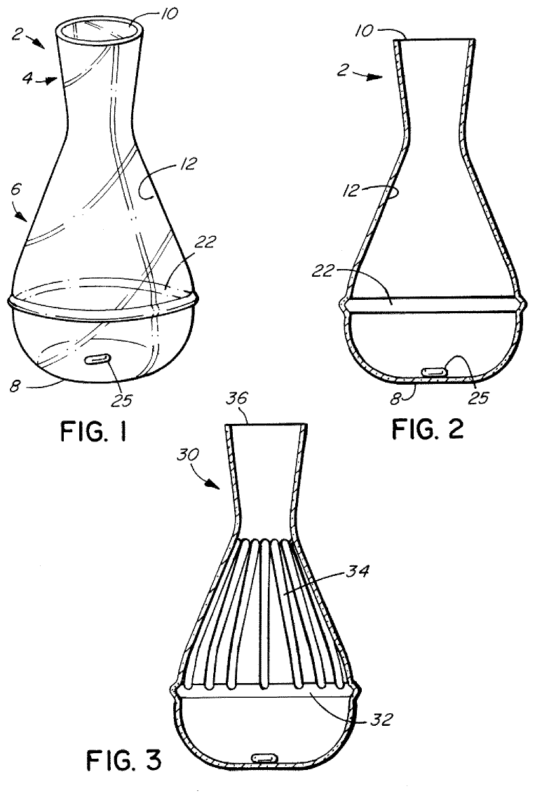

Now referring to FIG. 2, the container 2 has a recess 22 on the interior side of wall 12. The recess 22 preferably extends around the full interior perimeter of the container. Recess 22 is sufficiently wide and deep to catch and retain a magnetic stir bar 25 during pouring.

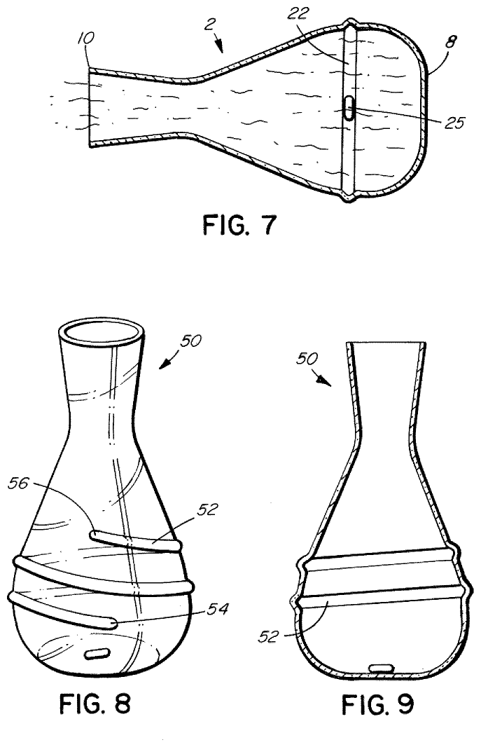

Magnetic stir bar 25 used for magnetic mixing typically sinks to the bottom of the substance(s) to be mixed and rests on the container's base 8 when the container is upright. FIGS. 6 and 7 show a mixed substance being poured from the container 2. During pouring, as the top 10 of the container is lowered and the bottom 8 of the container is raised, the magnetic stir bar 25 will slide up the interior side of container wall 12 towards the top 10 of the container under the influence of gravity and as a result of the flow of the mixed substance out of the container. Eventually if the container 10 is tilted to a sufficient degree, the magnetic stir bar will reach and fall into the recess 22 located on the interior side of wall 12 as illustrated in FIG. 6. FIG. 7 is a sectional view of FIG. 6 showing the stir bar 25 resting at the bottom of the channel 22 when the container is tilted on its side. The recess 22 thereby prevents the magnetic stir bar from sliding further towards the top 10 of the container and out of the container 2.

Now referring to an alternate embodiment of the invention shown in FIG. 3, container 30 has one or more drainage channels 34 that extend upwards from recess 32 towards the top 36 of the container. The size and shape of the drainage channels 34 allows the flow of substances out of the recess 32 and towards the top 36 of the container without permitting the magnetic stir bar to leave the recess 32 after it has fallen into the recess 32 during pouring. For instance, the one or more drainage channels 34 may be narrower and/or shallower than the recess 32.

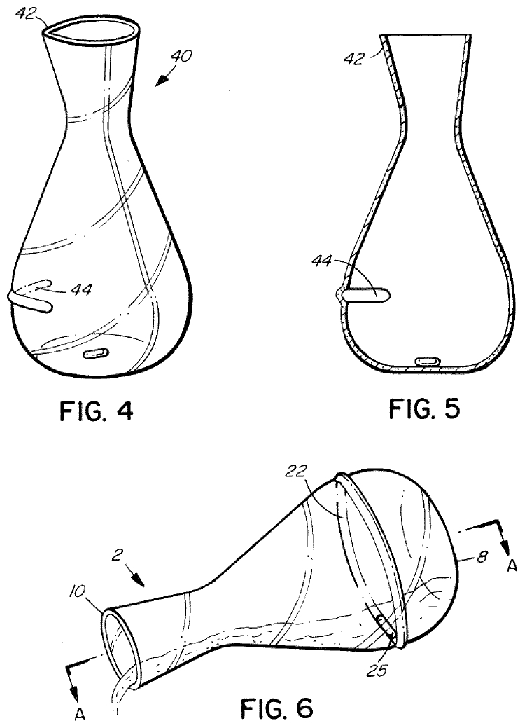

FIGS. 4 and 5 show a container having a spout 42. Since substances from such a container are normally poured out of the spout 42, the recess 44 for catching a magnetic stir bar does not need to extend around the full interior circumference of the container. Instead, the recess 44 may be present only on a portion of the interior wall below the spout 42. During pouring, the magnetic stir bar will move towards the spout and fall into the recess 44.

FIGS. 8 and 9 show an alternate embodiment of the invention in which the container 50 has a spiral recess 52 on a portion of the interior side of the container's wall. The spiral recess 52 has a lower end 54 and an upper end 56 and traps the stir bar while also allowing the liquid in the recess 52 to flow out of the container when the container is tilted. The spiral recess 52 should make at least one full rotation around interior side of the container's wall so that a magnetic stir bar sliding up the container's wall during pouring will eventually fall into the spiral recess 52 irrespective of the orientation of the container during pouring.

If the angle at which the spiral recess 52 extends up the container's wall is too steep, the magnet stir bar caught by the spiral recess 52 may slide up the spiral recess 52 towards upper end 56. The magnetic stir bar might then leave the spiral recess 52 as a result of gravity and the flow of liquid of out of the container. This is of particular concern where the spiral makes between one and one and a half rotations around the interior side of the container's wall. It will therefore be appreciated that the angle of the spiral recess 52 should not be too steep. Preferably the spiral recess 52 makes at least two full rotations around the interior side of the container's wall (as shown in FIGS. 8 and 9) to provide at least one full rotation of separation between upper end 56 and the portion of the spiral recess 52 that a magnetic stir bar falls into during pouring.

Various embodiments of the invention, including those shown in FIGS. 4, 5, 8, and 9, may also have one or more drainage channels extending upwards from the recess trapping means similar to the drainage channels 34 shown in FIG. 3 and described above.

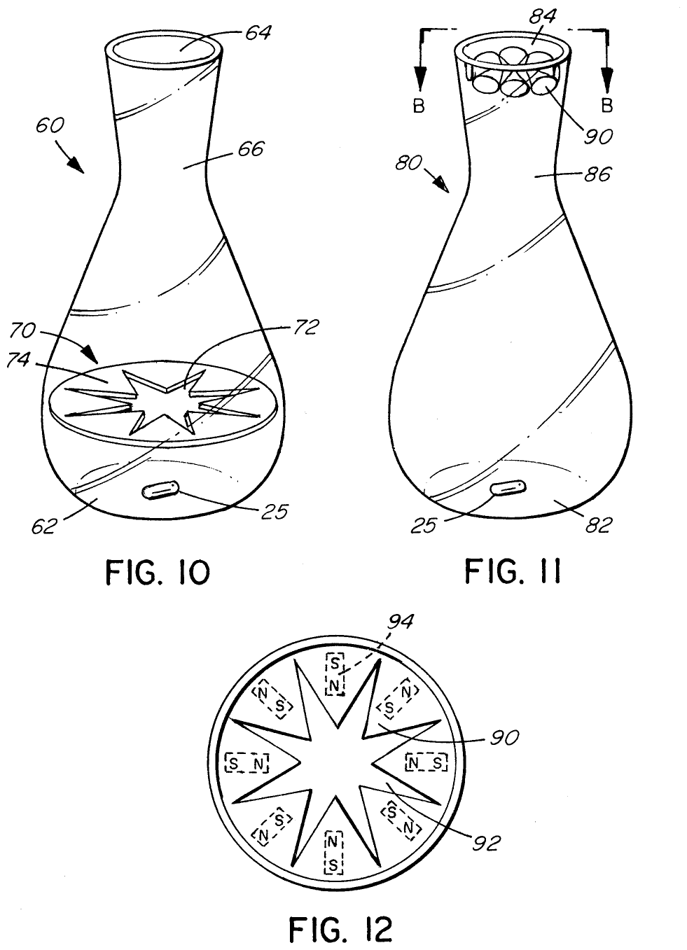

FIG. 10 shows an alternate embodiment of the invention in which container 60 has a restrainer 70 between the base 62 and opening 64. The restrainer 70 is shown as being a planar structure with a series of alternating projections 74 and spaces 72. The projections 74 extend inwards from the container's interior wall and may be connected or disconnected from one another.

While the restrainer 70 shown in FIG. 10 is below the tapered neck 66 of the container 70 and located in the bottom half of the container (closer to the base 62 than the opening 64), it will be appreciated that the location of restrainer 70 may be on the interior wall anywhere from slightly above base 62 (at a sufficient height above base 62 to allow for magnetic stir bar 25 to freely spin underneath) up to the opening 64.

In FIG. 10, the restrainer 70 is comprised of eight projections 70 extending inward from the interior surface of the wall of container 60. Both the projections 70 and the spaces 72 are shown as being triangular. However, the size, shape, and number of projections and spaces may vary. For instance, a larger number of generally rectangular shaped projections may be used.

During pouring, liquid within the container 60 freely flows through spaces 72 in the restrainer. However, the magnetic stir bar 25 is prevented from sliding up the full height of the container's wall and out of the opening 64 by projections 74 of the retainer 70. The spaces 72 are shaped and sized such that the magnetic stir bar 25 cannot pass through the spaces 72 during pouring. For example, if a magnetic stir bar has a diameter of 6 mm, space 72 would have a width smaller than 6 mm (such as a width of 5 mm). As the magnetic stir bar 25 typically sinks and will rest on the interior wall during pouring, the size and shape of the portion of the spaces 72 nearest to the interior wall is of greater importance than the size and shape of the portion of the spaces 72 closer to the centre of the container. In FIG. 10 for instance, the spaces 72 are narrowest at the points closest to the interior wall.

FIGS. 11 to 14 show another embodiment of a container 80 having a restrainer. The restrainer in container 80 is comprised of a series of projections 90 and spaces 92 between the projections 90.

While the projections 90 are shown as being conical in shape, it will be appreciated that the shape and size of the projections 90 can vary. For instance, projections 90 could be finger-like projections extending inwards from the interior wall of the container. In another example, the projections 90 could be U-shaped or V-shaped such that the opening of the U-shaped or V-shaped projections is directed downwards towards the base 82 of the container. In the U-shaped or V-shaped example, the magnetic stir bar 25 may enter into and be caught by the U-shaped or V-shaped projection during pouring.

As with the restrainer 70 shown FIG. 10, the location of the series of projections 90 and spaces 92 shown in FIG. 11 may vary from slightly above the base 82 up to the opening 84. In a wine decanter example, the series of projections 90 and spaces 92 could be located at, below, or above the tapered iii neck 86.

The projections 90 may have internal magnets that will magnetically couple to and retain magnetic stir bar 25 within the container 80 during pouring. FIG. 12 shows one such example of internal magnets 94 that may exist within projections 94. While magnets 94 with alternating orientations are shown in FIG. 12, it will be appreciated that the magnets can be orientated in the same direction (such as all the North ends directed inwards, or all the South ends directed inwards). It will also be appreciated that not all of the projections 90 may contain magnets 94. If spaces 92 are sufficiently narrow that magnetic stir bar 25 cannot physically pass through the series of projections 90, projections 90 will not require any magnets 94 to magnetically couple with the magnetic stir bar 25 during pouring.

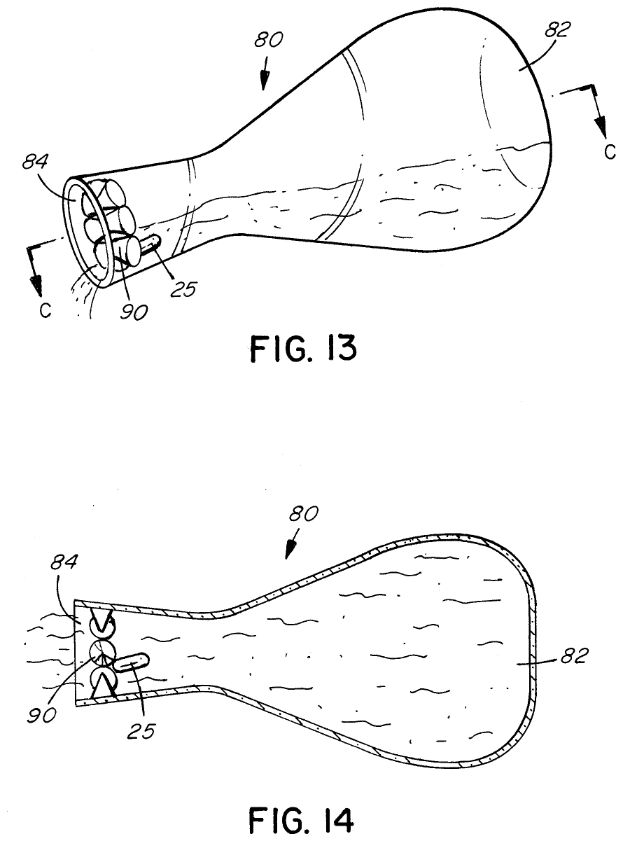

In FIGS. 13 and 14, a container 80 and magnetic stir bar 25 is shown with a liquid being poured out of the container. The base 82 is elevated and the opening 84 is lowered. While the liquid can flow around projections 90 and pass through spaces 92, the magnetic stir bar 25 cannot. Instead, the magnetic stir bar will reach the series of projections 90 and be physically, magnetically, or physically and magnetically restrained from exiting the container 80 during pouring.

Referring now back to FIGS. 4 and 5 showing a container 40 with a spout 42, the recess 44 could be substituted with one or more projections as described above. Similar to the recess 44, such projections may be on only the portion of the interior wall below spout 42 instead of extending around the full interior circumference of the container.

The container having a recess trapping means or having one or more restrainer projections may be sold alone or as an assembly with a magnetic mixer and a magnetic stir bar. A user, such as a homeowner, bartender, or barista can use the assembly to mix one or more alcoholic or non-alcoholic substances. The user places the one or more substance and a magnetic stir bar into the container. A magnetic mixer beneath the container is then powered and the magnetic coupling between the magnetic mixer and the magnetic stir bar across the base of the container causes the magnetic stir bar to spin within the container. This results in the mixture of the one or more substances within the container. Once the desired level of mixing is achieved, which may be selected by the user on the magnetic mixer, the container is lifted and the mixed substance(s) are poured out. It is not necessary to remove the magnetic stir bar prior to pouring since the magnetic stir bar will be caught and retained within the recess trapping means or by the one or more restrainer projections on the interior side wall of the container during pouring.

As one example, in a method of aerating wine by mixing, a magnetic stir bar and wine are placed into a wine decanter having recess trapping means (or one or more restrainer projections) according to the invention. The wine is then magnetically stirred and aerated using a magnetic mixer. Once stirring is complete, the wine may be poured directly from the decanter without needing to first remove the magnetic stir bar since the recess (or one or more restrainer projections) on the container retain the magnetic stir bar within the container. Other beverages or substances requiring mixing such as sports drinks made from crystals, cold brew coffee, or eggs for scrambled eggs may also be mixed using the container having recess trapping means (or one or more restrainer projections).

During magnetic mixing using the embodiment of the invention having a spiral recess, the spiral may facilitate the upwards movement of the substance being mixed along the interior wall of the container. In a wine aeration method, the greater surface area between the wine and air speeds up aeration. In a carbonation application, the greater surface area results in quicker carbonation.

In the foregoing description, exemplary modes for carrying out the invention in terms of examples have been described. However, the scope of the claims should not be limited by those examples, but should be given the broadest interpretation consistent with the description as a whole. The specification and drawings are, accordingly, to be regarded in an illustrative rather than a restrictive sense.

1. A container comprising:
a base;
an opening at the top of said container; and
a wall extending between said base and said opening, said wall comprising:
an interior side;
an exterior side; and
a recess on said interior side for catching a magnetic stir bar during the pouring of contents from said container.

2. The container of claim 1 wherein said recess on said interior side of said wall extends around the full interior perimeter of said interior side of said wall.

3. The container of claim 1 further comprising a spout at said opening and said recess being vertically aligned with said spout.

4. The container of claim 1 further comprising at least one drainage channel extending from said recess towards said opening.

5. The container of claim 4 wherein the depth of said at least one drainage channel is less than the depth of said recess such that a magnetic stir bar retained in said recess will not move into said at least one drainage channel during the pouring of contents from said container.

6. The container of claim 4 wherein the width of said at least one drainage channel is less than the width of said recess such that a magnetic stir bar retained in said recess will not move into said at least one drainage channel during the pouring of contents from said container.

7. The container of claim 1 wherein said recess is in the form of a spiral.

8. The container of claim 7 wherein said recess extends at least one full rotation around said interior side of said wall.

9. The container of claim 7 wherein said recess extends at least two full rotations around said interior side of said wall.

10. The container of claim 1 wherein said container is a wine decanter.

11. A container comprising:
a base;
an opening at the top of said container; and
a wall extending between said base and said opening, said wall comprising:
an interior side;
an exterior side; and
one or more projections extending inwards from the interior side for restraining a magnetic stir bar during the pouring of contents from said container.

12. The container of claim 11 wherein said one or more projections extend around the full interior perimeter of said interior side of said wall.

13. The container of claim 11 further comprising a spout at said opening and said one or more projections being vertically aligned with said spout.

14. The container of claim 11 wherein said one or more projections form a series of alternating projections and spaces.

15. The container of claim 11 wherein said one or more projections are conical in shape.

16. The container of claim 11 wherein said one or more projections are finger-like projections.

17. The container of claim 11 wherein at least one of said one or more projections has a magnet.

18. The container of claim 11 wherein said container is a wine decanter.

19. (canceled)

20. A method of mixing one or more substances, said method comprising:
placing the one or more substances in the container of claim 1;
placing a magnetic stir bar in said container;
powering a magnetic mixer below the container such the magnetic stir bar within the container spins to mix said one or more substances in the container; and
pouring said one or more substances from the container;
wherein during said pouring, said magnetic stir bar is caught by said recess on said interior side of said wall.

21. A method of mixing one or more substances, said method comprising:
placing the one or more substances in the container of claim 11,
placing a magnetic stir bar in said container;
powering a magnetic mixer below the container such the magnetic stir bar within the container spins to mix said one or more substances in the container; and
pouring said one or more substances from the container;
wherein during said pouring, said magnetic stir bar is restrained by said one or more projections.
